(19) United States
(12) Patent Application Publication
(10) Pub. No.: US 2003/0170909 A1
(43) Pub. Date: Sep. 11, 2003

(54) Solid phase environmental sampler

(76) Inventor: John C. Schaumloffel, Hamden, NY (US)

Correspondence Address: J. PETER FASSE, Fish & Richardson P.C., 225 Franklin Street, Boston, MA, 02110-2804, US

(21) Appl. No.: 10/241,310

(22) Filed: Sep. 10, 2002

Related U.S. Application Data
(60) Provisional application No. 60/318,483, filed on Sep. 10, 2001.

(51) Int. Cl. B01L 3/00

(52) U.S. Cl. 436/174; 422/99

(57) ABSTRACT

A rugged solid-phase extractant device is used to quantify or remove analytes from a variety of fluid environments.

### CROSS REFERENCE TO RELATED APPLICATION

This application claims benefit of priority from U.S. provisional patent application No. 60/318,483, filed on Sep. 10, 2001, which is incorporated herein by reference in its entirety.

### FIELD OF THE INVENTION

This invention relates to environmental sampling.

### BACKGROUND OF THE INVENTION

Environmental assessment and chemical extraction technologies have changed dramatically in the past two decades. However, many still require specially trained personnel, costly and environmentally unfriendly organic solvents, and substantial attention to chemical safety concerns. Traditional methods for extraction of organic compounds from solid, liquid, and gaseous samples involve a variety of procedures that involve liquid extraction. Liquid extractants are normally costly organic solvents (hexane, acetone, methylene chloride, etc.) that are used in relatively large volumes (5-1000 ml per extraction) and must be disposed of as hazardous waste.

Other existing methods can be more environmentally friendly and less expensive, yet still have limitations of their own. For example, supercritical fluid extraction (SFE) uses inert extractants such as water and carbon dioxide. However, SFE cannot be used in situ, because bulky instruments are needed to produce supercritical fluids.

Other methods include solid phase extraction (SPE) and solid phase microextraction (SPME). Traditional SPE devices, however, are not suitable for in situ extraction in dynamic systems, as they require a mechanism to draw the sample solution through the SPE cartridge. SPME relies on a solid-phase extractant that is coated on a thin, fragile (<1 mm diameter) quartz fiber. SPE and SPME have been used for the extraction of many analytes including chemical warfare agents, polychlorinated biphenyls (PCBs), total petroleum hydrocarbons (TPHs), herbicides, pesticides, polycyclic aromatic hydrocarbons (PAHs), drugs, and heavy metals. Supelco (a current division of Sigma-Aldrich, Inc.) currently sells one device representative of traditional SPME.

Other commercially available devices include semi-permeable membrane devices (SPMD's), which are not highly accurate. CIA Laboratories holds U.S. Pat. No. 5,098,573 for a semi-permeable membrane device (SPMD) that relies on the use of hazardous organic solvents and is fragile, being constructed primarily of thin polyethylene tubing. Several companies, including Alltech, Inc. and Supleco manufacture other solid phase based extraction devices. None, however, has the capacity for long-term deployment in abusive, dynamic environments.

Other commercially available technologies, such as the Gore SORBER® and GERSTAL® Lined Glass Extraction Devices, are not suitable for extractions in complex, abusive aquatic environmental systems or are designed primarily for the determination of volatile analytes in soil matrices.

### SUMMARY

The invention is based on the discovery that when a solid phase is properly packaged in a rugged exterior housing, it can be used for precise environmental sampling in harsh environments. Thus, the solid phase environmental sampler (SPES) allows for quantification and/or removal of analytes in many different locations.

In general, the invention features a sampling and extraction device that has a substantially rigid support housing that contains and protects a solid phase sorbent. During deployment, the solid phase sorbent extracts an analyte or analytes from fluid, e.g., water or air, flowing through the sampling and extraction device. This sampling and extraction device is capable of accurate sampling and/or extraction in abusive environments such as marine and fresh water environments.

In one aspect, the invention features an apparatus for extracting an analyte from a fluid environment that includes a solid phase sorbent for extracting an analyte from a fluid contacting the solid phase; and a substantially rigid hollow housing for retaining the solid phase; wherein the housing comprises one or more openings that are of a size to enable fluid from the fluid environment to enter and contact the solid phase sorbent, but not to enable the solid phase sorbent to exit the housing.

In this apparatus, the sorbent can be particulate, and the housing can further include one or more screens in which the openings have a diameter smaller than a size of the particulate sorbent. The sorbent can be selected from the list in Table 1 herein, e.g., polydimethylsiloxane (PDMS). The sorbent can be in the form of a sheet, or can be coated on a sheet, e.g., of a polymer, metal, or plastic. For example, the sorbent sheet can be rolled into a cylindrical spiral that is inserted into the hollow housing. In some embodiments, the housing includes (or is) a stainless steel support frame. In some embodiments, the housing can further include a loop, e.g., to connect the housing to a tether or rope for retrieval.

In these devices, the sorbent can be specifically selected to bind to an analyte selected from the group consisting of a chemical warfare agent, a polychlorinated biphenyl, a petroleum hydrocarbon, an herbicide, a pesticide, a polycyclic aromatic hydrocarbon, a drug, or a heavy metal. The device can include more than one sorbent, e.g., two, three, or more sorbents can be used in the same device, depending on the target analytes.

In another aspect, the invention features a method of extracting an analyte from a fluid environment by obtaining one of the new apparatus described herein, introducing the apparatus into the fluid environment for a period of time sufficient for any analyte in the fluid environment to be bound to the sorbent in the apparatus; removing the apparatus from the fluid environment; and removing the analyte from the sorbent, thereby extracting the analyte from the fluid environment. For example, the fluid environment can be water, such as an ocean, river, stream, or lake.

In other embodiments, the fluid environment can be air. The period of time can be one to seven days, or much longer. Where the analyte is a pollutant, the fluid environment to be tested may be in the vicinity of a source of the pollutant. The analytes can be any one or more of a wide variety of compounds, such as chemical warfare agents, polychlorinated biphenyls, petroleum hydrocarbons, herbicides, pesticides, polycyclic aromatic hydrocarbons, drugs, or heavy metals. For each analyte there is a sorbent. For example, the sorbents can be selected from the list in Table 1, e.g., PDMS.

The invention can also feature a reusable support frame, a reusable solid phase, the use of multiple extractants, a non-particulate solid phase, and a particulate solid phase. In addition, the SPES can be used to extract and/or sample many different compounds, each with different chemical properties. Many SPES applications also require no hazardous chemicals.

The SPES can also be deployed for a long period of time, e.g., for a week, month, or even a year or more, in a variety of environments. It may also be deployed in the air, on the ground, under the ground, or in bodies of water.

“Suitability” is defined as a demonstrated ability to accumulate analyte by both absorption and adsorption (demonstrated by logarithmic uptake curves or profiles) and the ability of the solid phase to absorb the analyte in quantities proportional to their concentration in solution.

The invention provides several advantages. For example, hazardous organic solvents that are generally quite expensive are not required to operate the invention. Furthermore, the durability of the new devices allows them to be employed in abusive and dynamic environments for long periods of time. Additionally, when the new devices are deployed in an environment with one or more contaminants, little or none of the original sample is returned to the laboratory. This feature minimizes the potential for contamination of sites to which the invention can be taken for analysis.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description.

### BRIEF DESCRIPTION OF DRAWINGS

FIG. 1 is a schematic diagram of a solid phase environmental sampler (SPES) deployed in a body of water.

FIG. 2 is a schematic diagram of an SPES for measuring atmospheric analyte concentration.

FIG. 3 is a formula illustrating the speed of adsorption of analytes for SPME fibers.

FIG. 4 is a formula showing the speed of adsorption of analytes for solid phase polydimethylsiloxane (PDMS).

FIG. 5A is a schematic showing analyte adsorbed on the surface of a solid support.

FIG. 5B is a schematic illustrating analyte trapped in a cross-linked substrate.

FIG. 6 is a picture of an SPES frame used together with a data-logging thermometer.

FIG. 7 is a schematic diagram of an SPES frame with two screens to retain a solid phase.

FIG. 8 is a schematic diagram of an SPES frame with a spiral roll of solid phase.

FIG. 9 is a chromatogram of uncleaned, back-extracted PDMS.

FIG. 10 is a chromatogram of MeOH-cleaned-back-extracted PDMS (spiked with PAHs to show retention times and lack of interference for these compounds).

FIG. 11 is a graph illustrating the uptake profile for agricultural chemicals using commercially available SPME fibers.

FIG. 12A is a graph showing the uptake profile of 100 ppb lindane in seawater.

FIG. 12B is a graph illustrating the uptake profile of 1000 ppb arochlor 1254 in water.

FIG. 13A is a graph showing the calibration curve for arochlor 1254 extracted from spiked seawater.

FIG. 13B is a graph showing the calibration curve for lindane extracted from spiked seawater.

FIG. 14 is a graph illustrating standard (top) and field (bottom) extract chromatograms of arochlor 1242 determined using an SPES in a river estuary.

### DETAILED DESCRIPTION

The present invention provides a solid phase environmental sampler (SPES) and methods of use. The SPES itself often utilizes an inexpensive polymeric solid phase to extract organic contaminants from aqueous solutions or from the atmosphere. The solid phase is contained in a rugged and reusable stainless steel support frame when it is deployed in bodies of water or in or on the ground. When deployed in the air, a sturdy, but relatively lightweight frame can be used.

Preparing SPESs

The SPES functions by physical adsorption of non-polar and sparingly soluble organic compounds to the solid phase. The device can extract target classes of compounds such as polychlorinated biphenyls (PCBs), polycyclic aromatic hydrocarbons (PAHs), chlorinated herbicides, and other compounds. An SPES is simple to use. The SPES frame (for on or under-earth applications) is loaded with the polymeric solid phase extractant. Upon exposure to the sample, soluble and sparingly soluble organic compounds partition from the aqueous (or gaseous) phase to the solid phase. After removal from the sample, the analytes of interest are back-extracted from the SPES using an environmentally friendly or “Green” extractant (e.g., methanol). The back-extracted solution is analyzed to determine the presence and concentration of target analytes and unknown compounds. The entire process, including sampling, can take place in less than 60 minutes, or the sampler can be deployed for weeks or months, and up to years at a time. For most efficient sampling, the SPES should be allowed to reach equilibrium with the sample (˜1-7 days).

The Solid Phase

The solid phase can be comprised of any one (or more) of a number of sorbents. Table 1, adapted from Mills (1998) Solid-Phase Extraction, lists some common sorbents available for SPE that may also be used in the new SPES.

TABLE 1
Common Sorbents Available for SPES

| | | |
|---|---|---|
| Sorbent | Structure | Typical Loading |

Reversed Phase

| | | |
|---|---|---|
| Octadecyl | -(CH₂)₁₇CH₃ | 17%C |
| (C-18) | | |
| Octyl (C-8) | -(CH₂)₇CH₃ | 14%C |
| Ethyl (C-2) | -CH₂CH₃ | 4.8%C |
| Cyclohexyl | -CH₂CH₂-cyclohexyl | 12%C |
| Phenyl | -CH₂CH₂CH₂-Phenyl | 10.6% |
| Graphitized | Aromatic carbon throughout | |
| carbon | | |
| Copolymers | Styrene-divinylbenzene | |

Normal Phase

| | | |
|---|---|---|
| Cyano (CN) | -(CH₂)₃CN | 10.5%C, 2.4%N |
| Amino (NH₂) | -(CH₂)₃NH₂ | 6.4%C, 2.2%N |
| Diol (COHCOH) | -(CH₂)₃OCH₂CH(OH)CH₂(OH) | 8.6%C |
| Silica gel | -SiOH | — |
| Florisil | Mg₂SiO₃ | — |
| Alumina | Al₂O₃ | — |

Ion Exchangers

| | | |
|---|---|---|
| Amino (NH₂) | -(CH₂)₃NH₂ | 1.6 meq/g |
| Quaternary | -(CH₂)₃N⁺(CH₃)₃ | 0.7 meq/g |
| amine | | |
| Carboxylic | -(CH₂)₂COOH | 0.4 meq/g |
| acid | | |
| Aromatic | -(CH₂)₃-Phenyl-SO₃H | 1.0 meq/g |
| sulfonic | | |
| acid | | |

Size Exclusion

| | | |
|---|---|---|
| Wide pore | -(CH₂)₃CH₃ | 5.9%C |
| hydrophobic | | |
| (Butyl) | | |
| Wide pore | -COOH | 12.2%C |
| ion exchangers | | |

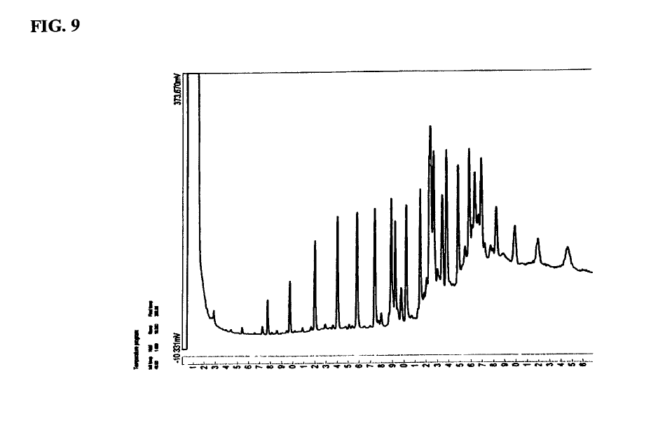

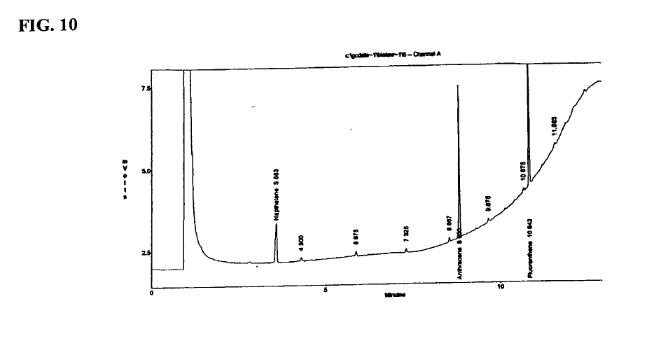

A number of solid-phase preparation procedures may be used in the current invention. When using PDMS, the invention can utilize the Dow® SYLGARD® 184 cross-linked PDMS polymer. Preparation using that polymer begins with a cured, degassed PDMS block that is ground in a methanol slurry. The slurry is then put through a sieve to achieve a consistent size range of particles. Subsequent to this, the PDMS is cleaned. Repetitive methanol washing, combined with sonication, reduces the background signal from the PDMS to acceptable levels. The chromatogram in FIG. 9 shows the background signal from uncleaned PDMS. This signal can be compared to the signal from MeOH-cleaned PDMS shown in FIG. 10. In the latter figure, analytes of interest (specifically PAHs) were spiked into the extract solution to demonstrate that there were no interference peaks in the chromatogram of the extracted, cleaned PDMS. Additionally, using 7-10 PDMS, i.e., PDMS that passed through a size 7 mesh screen, but which did not pass through a size 10 mesh screen (yielding a 2.00-2.80 mm particle size), reduced recovery reproducibility to 10-15% (% relative standard deviation) for the extraction of a 100 ppb spiked lindane solution, a level considered acceptable under most regulatory protocols. Improving particle size homogeneity can reduce this value to 5-10%.

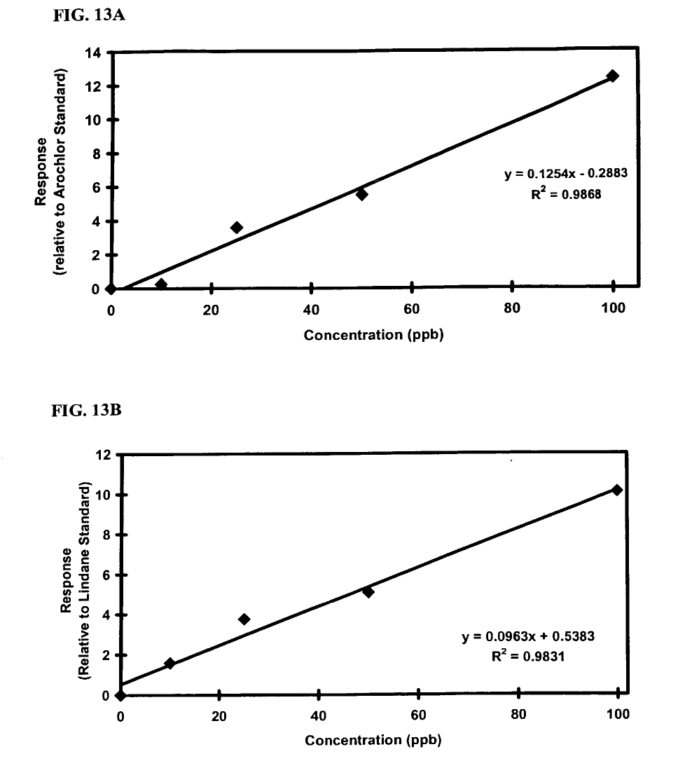

The amount absorbed by the PDMS solid phase is proportional to the concentration of the analyte in solution. Indeed, if this were not so, the extraction method would be limited in its applicability. FIGS. 13A and 13B demonstrate that the PDMS solid phase particles accumulate analytes in direct proportion to their concentration.

The SPES can also be loaded with chemically modified PDMS or alternative solid phases, which can be used to extract additional contaminants. For example, one method involves impregnating the PDMS solid phase with ion-exchange resins. By using ion-exchange resins, this new solid phase is suitable for the extraction of metals and radionuclides (as monatomic and polyatomic ions) from contaminated waters.

When the invention utilizes a polymeric solid that is not coated on a solid support (as in traditional SPE or SPME), there is no adhesive joint to crack or wear. The solid phase is, thus reusable after cleaning. Moreover, it retains its cost effectiveness even if it is used as a one-time use device ($˜3/extraction).

In addition to using a particulate solid phase, the SPES can also use a variety of other solid phases. The solid phase can be comprised of a solid mass of extractant. While the surface area of the extractant exposed to the sample is diminished when a solid mass is used, in some applications, large extractant surface area may not be required.

The solid phase can also be comprised of a sheet of an extractant or a sheet of an inert substance (with respect to the analyte of interest) coated with an extractant or multiple extractants. The SPES can then be loaded with one or more such sheets.

When the SPES frame is small, a sheet comprised of (or coated with) the extractant may be rolled into a spiral or folded (see FIG. 8). Many such sheets may be rolled or folded and placed within the frame. Furthermore, many sheets may be laid on top of one another and rolled into a spiral, leaving space (e.g., with a plastic or metal spacer) between the layers or rolls. Thus, liquid samples will flow between the spaces not occupied by the sheets.

Sheets can also be constructed with one extractant coating one side of the sheet, and a different extractant coating the other. Similarly, one side of a sheet can be divided in two (or it can be divided even more finely), with one extractant covering one half of the sheet, and another extractant covering the other half of the sheet. A similar division can also be used on the other side of that sheet.

Each of the described solid phases may be used either by themselves, or in conjunction with each other, simultaneously in the SPES frame (described below).

Housings and Frames

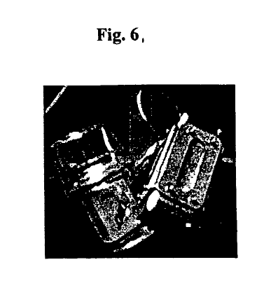

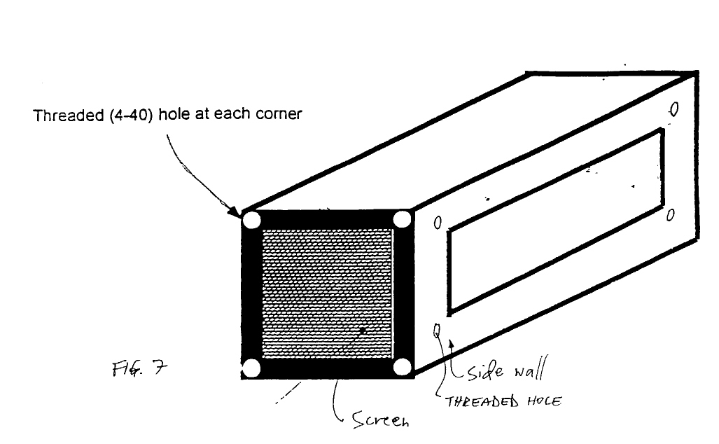

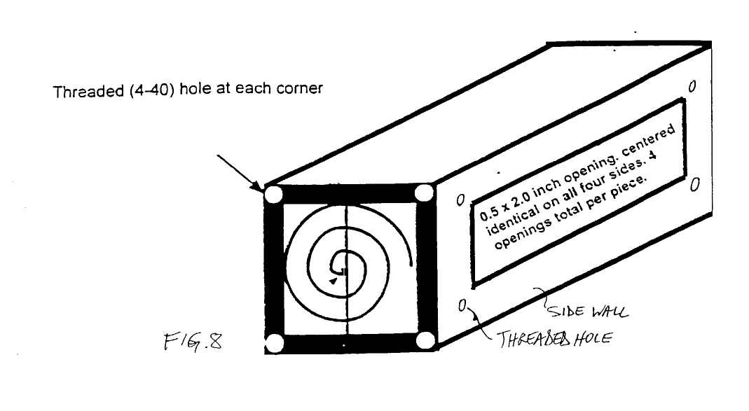

The use of a suitable housing, e.g., a frame, is important in environmental sampling. FIG. 6 shows an SPES housing (right) as used with a data-logging thermometer (left). FIGS. 7 and 8 show SPES housing, which are suitable for abusive environments, are reusable, and protect the solid phase from organisms and biota. In FIG. 7, the housing has an outer frame that carries screens (e.g., 304 SS (stainless steel) with 0.1 mm diameter openings) that are placed over the two ends of the frame. The openings in the screen are smaller than the particle size of the solid phase such as PDMS (when using a particulate solid phase) so that the SPES retains its solid phase, but allows the sample (e.g., water or air) to flow inside the SPES without mechanical pumping. The screen also functions to keep large particulate matter from the sample from entering into the body of the SPES and interfering with proper functioning of the SPES.

In this example, the body or housing has a frame made of 304 SS, and can be about 3 to 5 or 10 inches long, e.g., 3.125 inches long, and about 1.0 to 5.0 inches wide, e.g., about 1.5 inches on each side. The side walls and end covers can be made of flat 304 SS stock that is, e.g., 0.125 inches thick. The frame can have through holes, e.g., four on each end in the corners, and four on each side wall, also close to the corners, as shown in FIG. 7 to connect the frame to other devices, tethers, loops, ropes, etc. The side walls can have openings, e.g., 0.5 by 2.0 inches, or some other size that prevents the sorbent from falling out of the housing. FIG. 8 shows a similar SPES housing, but containing a spiral roll made of a thin (e.g., 127 micrometer) sheet of PDMS.

The frame can be subdivided into many different sections so that multiple extractants can be employed in the SPES. Care should be taken that the structure that performs the division does not obstruct the flow of fluid through the SPES as that could interfere with proper sampling or analyte collection. A screen is a useful dividing structure that does not impede SPES functioning.

Methods of Use

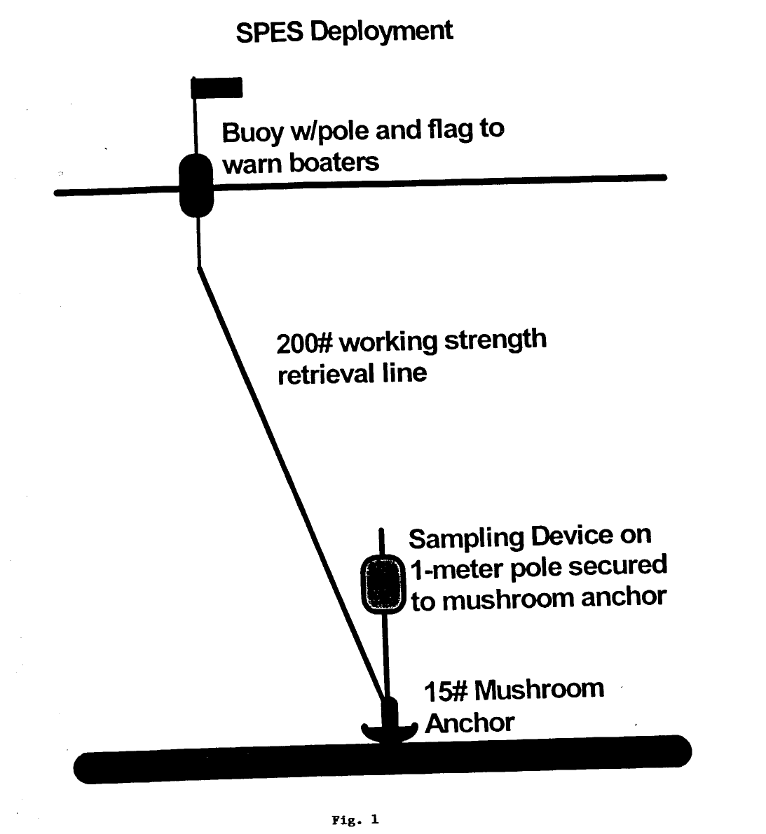

An SPES does not require the use of hazardous organic solvents (e.g., methylene chloride), but it easily and simply pre-concentrates and extracts target analyte classes from solution, and can be used by non-specialists in abusive environs. Such uses include burying the SPES in an underground aquifer to accumulate target analytes for both qualitative and quantitative analysis. SPESs can also be placed into industrial waste streams at the beginning of a production cycle and analyzed at known intervals to monitor effluent composition. Additionally, SPESs can be employed as long-term environmental monitors (essentially as a contaminant accumulation device) in remote environments such as offshore platforms (e.g., oil rigs) or used regionally by attachment to navigation buoys. For example, FIG. 1 shows the use of an SPES connected to an anchor, such as a mushroom type anchor, by a pole that keeps the device above any mud or vegetation at the bottom of the water. The anchor is connected to a long retrieval line that is connected to a buoy with a pole and flag to warn boaters.

Alternatively, the SPES can be placed by an unmanned submersible, aerial, or land-based vehicle into hazardous environments (e.g., military theaters of operation), allowed to extract analytes for analysis, and then be retrieved and returned to the laboratory for analysis. For example, the SPES may include a retrieval tether that has a loop that can be picked up remotely by a military vehicle.

One advantage of the new SPES devices is that little or none of the original sample is returned, minimizing the potential for contamination of the laboratory and preventing the spread of contaminants.

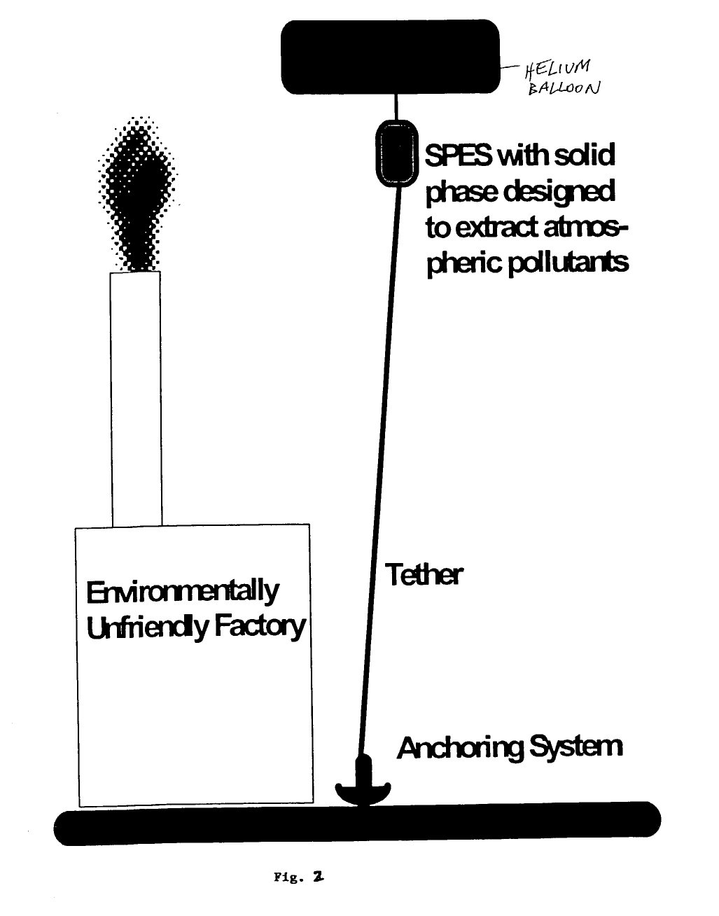

The SPES can also be employed in the atmosphere using a balloon, pole, or some other mounting mechanism. As shown in FIG. 2, when used in this manner, the SPES is ideal for monitoring atmospheric pollutants, e.g., in the vicinity of factories that may be producing smoke or pollutants.

Calibration and Sample Analysis

The SPES is calibrated by exposing a known mass of solid phase in the laboratory for a predetermined length of time, at a temperature and ionic strength similar to the conditions expected during use. The frame is not needed for the laboratory calibration. Subsequently, the calibration solid phase is exposed and treated under the same conditions as the sample solid phase, e.g., same temperature, time interval, and ionic strength. SPES can extract analytes from thousands of liters of sample solution, and concentrate them into volumes as small as 1.5 ml. While calibration and analysis of extracted field samples need to be performed under similar conditions (temperature, exposure time, ionic strength, etc.), they do not need to be performed simultaneously. For example, calibration can be done before or after the SPES is put into use, and analysis of the collected sample can be done hours, days, or weeks after the sample is collected.

As indicated, the SPES functions because non-polar and sparingly soluble organic compounds partition from the aqueous/gaseous phase onto the solid phase in the SPES device. The relationship between the extraction parameters and the quantity of analyte extracted, once an equilibrium condition is reached, is shown below (Pawliszyn, J. SPME: Theory and Practice. Wiley-VCH: New York, 1997):

$$n = \frac{{K}_{f s} \cdot {V}_{f} \cdot {V}_{s} \cdot {C}_{o}}{{K}_{f s} \cdot {V}_{f} + {V}_{s}}$$

Where:

n=the amount of analyte extracted by the solid phase

K_{fs}=the solid phase/sample solution distribution constant

V_{f}=the volume of the solid phase

Vₛ=the sample volume

Cₒ=is the concentration of the analyte in the sample

When using the SPES in large, bulk solutions such as oceans, harbors, rivers, and aquifers, the concentration of the analyte (Cₒ) will remain essentially constant. There exists an essentially continuous supply of analyte from the bulk solution, which has an enormous volume compared to the solid phase (Vₛ>>>V_{f}). The distribution constant (also called distribution coefficient) is largely a function of the analyte of interest and the solid phase extractant being employed. It is also a function of pH, temperature and, to some extent, solution ionic strength.

The field deployable SPES is equipped with a data-logging thermometer (such as the one manufactured by Onset Computer Co, Bourne, Mass.)(see FIG. 6). Upon retrieval of the SPES, the mean temperature and temperature range will be evaluated to ascertain the appropriate temperature at which to calibrate the SPES in the laboratory. Calibration will take place in low (freshwater) or high (marine) ionic strength solutions to maximize the homogeneity of solutions to which the field and laboratory (calibration) solid are exposed. Extraction of the existing suite of analytes is not pH dependent, as they exist as neutral species in aqueous solution.

Pesticide-grade (high purity) methanol (MeOH) is one back-extractant used in the current invention. MeOH is inexpensive and environmentally benign. More importantly, MeOH can be integrated into an aqueous waste disposal stream, and MeOH solutions destined for chemical analysis or disposal can be easily reduced in volume by condensation or evaporation due to the modestly low boiling point for MeOH. MeOH maintains both polar (—OH) and non-polar (CH₃) moieties, making it suitable for the back-extraction of both non-polar and potentially polar species from the solid phase. Hexane is a possible back-extractant, but causes disruptions in the PDMS matrix. These disruptions can cause the PDMS to swell, resulting in irreproducible extraction recoveries.

Adsorption and Absorption

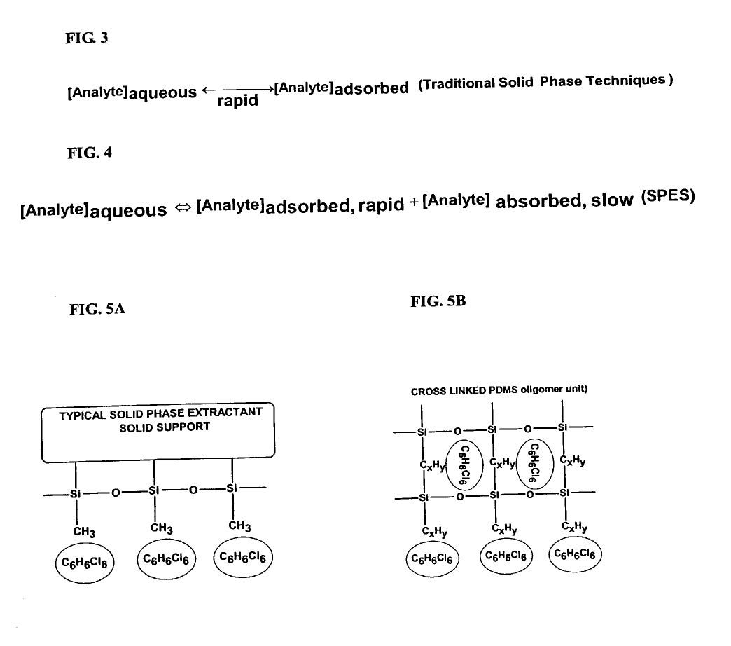

The SPES is unlike other sampling devices for organic pollutants because it absorbs contaminants into the interior of the solid phase, rather than just adsorbing them onto the surface. SPME, SPE, and other techniques rely primarily on relatively rapid surface adsorption of analytes (Pawliszyn, J. SPME: Theory and Practice, Wiley-VCH: New York, 1997; Thurman, E. and Mills, M. SPE: Principles and Practice, John Wiley and Sons: New York, 1998). In addition to physical shortcomings (fragility), this use of adsorption causes other devices to be susceptible to loss of analyte molecules via rapid desorption if conditions in the environment (e.g., temperature) change. The formula in FIG. 3 demonstrates how the adsorption of analytes onto SPME fibers is rapid, with equilibrium between the solid phase occurring less than an hour after exposure to the sample. Comparatively, the formula in FIG. 4 shows that uptake of analytes (adsorption and absorption) when the PDMS solid phase is used in the SPES, is relatively slow. As a result, the SPES is much more suitable for long-term and field studies during which short-term changes in environmental conditions will not affect the mass accumulated in the SPES and therefore not substantially alter the analytical results.

As a result of both the adsorption and absorption processes, if one were to examine the PDMS at a molecular level, the solid phase exposed to a sample would have the appearance depicted in FIG. 5B, with analyte molecules essentially trapped in the solid phase matrix until released by a suitable solvent. This is shown schematically in FIGS. 5A and 5B, which show lindane molecules (C₆H₆Cl₆) trapped in a cross-linked PDMS (FIG. 5B) as well as adsorbed on a surface (FIG. 5A).

From a practical standpoint, the ability to take advantage of absorption as a substantial uptake mechanism makes the capacity of the SPES much greater than thin film solid phase sampling devices (e.g., SPME) or those that rely on thin-layer bonded phases (SPE), because the PDMS solid phase particles utilized in one embodiment of the current invention are essentially their own solid support, adsorbent, and absorbent. Unlike thin-layer bonded phases, there exists no joint or mechanical bond to wear out or break.

Table 2, below, indicates the suitability of the cross-linked PDMS for determining different compounds.

TABLE 2
Suitability of PDMS Solids for Compound
Extraction from Spiked Seawater

| | | | PDMS |
|---|---|---|---|
| Compound | CAS # | Formula | Suitability |
| Lindane | 58-89-9 | C₆H₆C₁₆ | Yes |
| Triallate | 2303-17-5 | C₁₀H₁₆Cl₃NOS | Yes |
| Tetrachloro m- | 877-09-8 | C₈H₆Cl₄ | No |
| xylene | | | |
| Arochlor 1254 | 11097-69-1 | PCB mixture | Yes |
| Arochlor 1242 | 53469-21-9 | PCB mixture | Yes |
| Naphthalene | 91-20-3 | C₁₀H₈ | Yes |

### EXAMPLES

The invention is further described in the following examples, which do not limit the scope of the invention. The examples describe using a particulate solid phase, testing the SPES against a known method, and using the SPES in a river estuary.

Example 1

Preparation of SPES with Particulate Solid Phase

A Dow® SYLGARD® cross-linked PDMS polymer precursor was degassed and cured. The block was then ground and sieved to achieve a consistent size range of particles. Subsequently, the PDMS was cleaned with MeOH. Repetitive MeOH washing, combined with sonication, reduced the background signal from the PDMS to acceptable levels. The chromatogram in FIG. 9 shows the background signal from uncleaned PDMS. This signal can be compared to the signal from MeOH-cleaned PDMS shown in FIG. 10. In the latter figure, analytes of interest (specifically PAHs) were spiked into the extract solution to demonstrate that there were no interference peaks in the chromatogram of the extracted, cleaned PDMS. Additionally, using 7-10 mesh (2.00-2.80 mm particle size) PDMS reduced recovery reproducibility to 10-15% (% relative standard deviation) for the extraction of a 100 ppb spiked lindane solution, a level considered acceptable under most regulatory protocols. Improving particle size homogeneity reduced this value to 5-10%.

Example 2

Testing of SPES

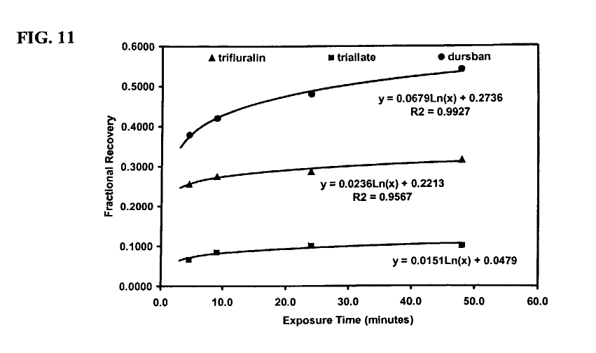

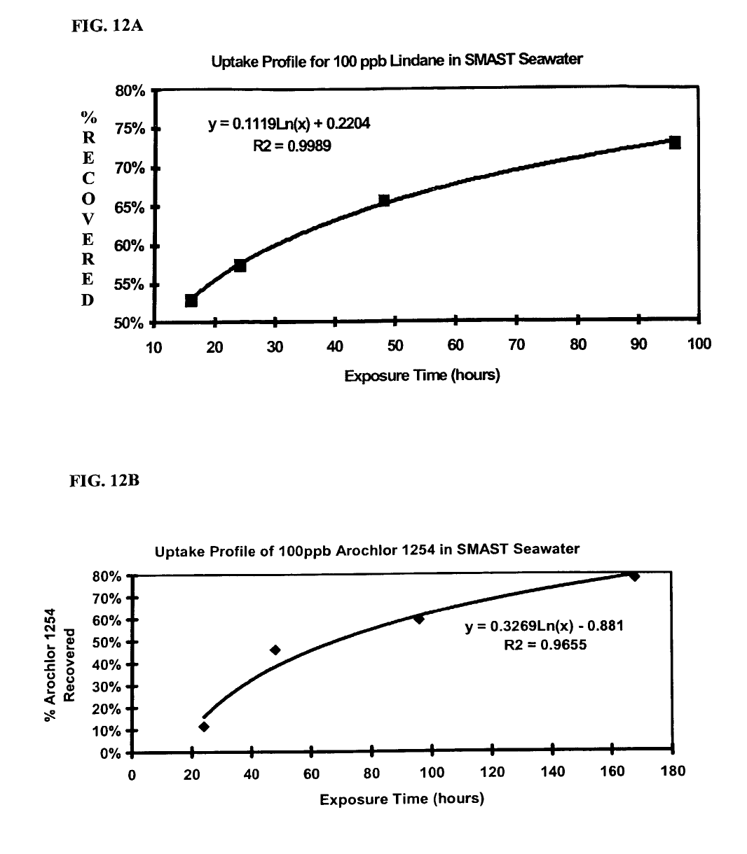

Comparing the use of the PDMS solid phase (in particle form) to other solid phase extraction technologies illustrated that the uptake of selected analytes from seawater samples using a PDMS solid phase was similar to that for other known techniques. FIG. 10 shows an uptake profile (% of fraction of analyte removed from solution versus exposure time) for the SPME method (a commercially available technique). FIG. 11 is a graph illustrating the uptake profile for agricultural chemicals using commercially available SPME fibers and standard techniques. FIGS. 12A and 12B, in comparison show two uptake profiles for the extraction of Lindane and Arochlor 1254 (a PCB) using the PDMS solid phase. As can be seen by comparison, the logarithmic uptake profiles for both solid phase techniques are similar, although the exposure times for the PDMS solid phase are intentionally longer. When employing the SPES in long-term experiments, a slower uptake of contaminants is advantageous, especially when combined with greater reproducibility and less susceptibility to short-term environmental variations (e.g., temperature, salinity).

Slower uptake of analytes, which includes both analyte adsorption and absorption, is the tradeoff that allows for greater analyte accumulation capacity of the SPES compared to other solid phase extraction techniques.

The amount absorbed by the PDMS solid phase is proportional to the concentration of the analyte in solution. The graphs in FIG. 13A (calibration curve for arochlor 1254) and 13B (calibration curve for lindane) demonstrate that the PDMS solid phase particles accumulated analytes in direct proportion to their concentration.

Example 3

Use of SPES in River Estuary

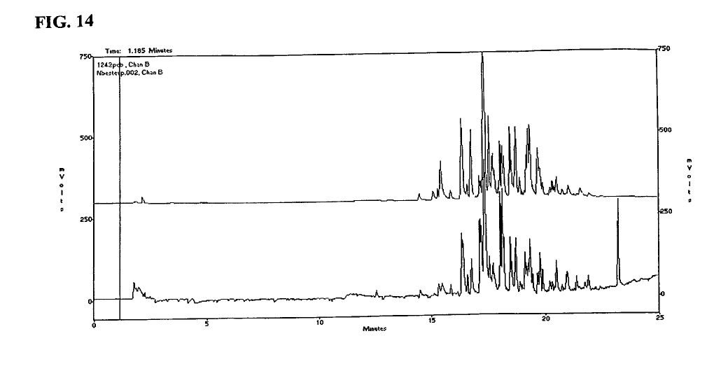

The successful field deployment of the SPES frame and associated apparatus in the Acushnet River estuary is now described. A PDMS solid phase was used to extract PCBs. In situ, the SPES withstood the rigors of the environment, and was used in conjunction with an anchor-buoy system (as shown in FIG. 1) that both stabilized the SPES and kept it from shifting locations in strong currents. FIG. 14 contains chromatograms for both an Arochlor 1242 (a PCB) standard and the back-extracted PDMS solid phase from the SPES deployed in the estuary. The representative set of peaks normally seen from Arochlors is seen in both the standard and field chromatogram. The difference between them is likely due to chemical and biological PCB alteration and degradation occurring in the system.

Other Embodiments

It is to be understood that while the invention has been described in conjunction with the detailed description thereof, the foregoing description is intended to illustrate and not limit the scope of the invention. Other aspects, advantages, and modifications are within the scope of this invention.

What is claimed is:

1. An apparatus for extracting an analyte from a fluid environment comprising:
a solid phase sorbent for extracting an analyte from a fluid contacting the solid phase; and
a substantially rigid hollow housing for retaining the solid phase; wherein the housing comprises one or more openings that are of a size to enable fluid from the fluid environment to enter and contact the solid phase sorbent, but not to enable the solid phase sorbent to exit the housing.

2. The apparatus of claim 1, wherein the sorbent is particulate, and wherein the housing further comprises a screen in which the openings have a diameter smaller than a size of the particulate sorbent.

3. The apparatus of claim 1, wherein the sorbent is selected from the list in Table 1.

4. The apparatus of claim 1, wherein the sorbent is polydimethylsiloxane (PDMS).

5. The apparatus of claim 1, wherein the sorbent comprises a sheet.

6. The apparatus of claim 1, wherein the sorbent is coated on a sheet.

7. The apparatus of claim 5, wherein the sorbent sheet is rolled into a cylindrical spiral that is inserted into the hollow housing.

8. The apparatus of claim 1, wherein the housing comprises a stainless steel support frame.

9. The apparatus of claim 1, wherein the housing further comprises a loop to connect the housing to a tether.

10. The apparatus of claim 1, wherein the sorbent is selected to bind to an analyte selected from the group consisting of a chemical warfare agent, a polychlorinated biphenyl, a petroleum hydrocarbon, an herbicide, a pesticide, a polycyclic aromatic hydrocarbon, a drug, or a heavy metal.

11. A method of extracting an analyte from a fluid environment, the method comprising
obtaining an apparatus of claim 1;
introducing the apparatus into the fluid environment for a period of time sufficient for any analyte in the fluid environment to be bound to the sorbent in the apparatus;
removing the apparatus from the fluid environment; and
removing the analyte from the sorbent, thereby extracting the analyte from the fluid environment.

12. The method of claim 11, wherein the fluid environment is water.

13. The method of claim 11, wherein the fluid environment is an ocean.

14. The method of claim 11, wherein the fluid environment is air.

15. The method of claim 11, wherein the period of time is one to seven days.

16. The method of claim 11, wherein the analyte is a pollutant, and the fluid environment is in the vicinity of a source of the pollutant.

17. The method of claim 11, wherein the analyte is a chemical warfare agent, a polychlorinated biphenyl, a petroleum hydrocarbon, an herbicide, a pesticide, a polycyclic aromatic hydrocarbon, a drug, or a heavy metal.

18. The method of claim 11, wherein the sorbent is selected from the list in Table 1.

19. The method of claim 11, wherein the sorbent is polydimethylsiloxane (PDMS).
